(19) United States
(12) Patent Application Publication
(10) Pub. No.: US 2016/0288772 A1
(43) Pub. Date: Oct. 6, 2016

(54) Adaptable interim repair jacket to supplant a failed windshield wiper structure of a motor vehicle

(71) Applicant: David Allen Stewart, Petal, MS (US)

(72) Inventor: David Allen Stewart, Petal, MS (US)

(21) Appl. No.: 14/545,132

(22) Filed: Mar. 31, 2015

(51) Int. Cl. B60S 1/38; B60S 1/04

(52) U.S. Cl. CPC B60S 1/38; B60S 1/0491; B60S 2001/3829; B60S 2001/3836; B60S 2001/3827

(57) ABSTRACT

An adaptable short term repair jacket 2 for temporary continued operation of a damaged or failed windshield wiper frame assembly and/or wiper blade of a powered windshield wiper system of a motor vehicle. Disclosed here an elongated generally tubular plastic casing 4 including an upper centrally open guide gap 12. Each linear side includes a flexible convex upper sidewall 6. Each sidewall 6 transitions into a linear concave lower sidewall 8 respectively. Sidewalls 8,8 converge respectively to the linear underside of jacket 2 forming a linear fold crease 10. An elongated rubber core 32 is adjoined to the linear outer side of crease 10. Jacket 2 is placed in alignment, end to end with an existing damaged or failed wiper structure and slid over the failed wiper to provide provisional wiper operation allowing for continued travel of a vehicle during rain/precipitation, in addition the jacket will prevent scratching and chipping damage to a windshield by the containment of flailing and scraping metal or plastic parts of a damaged in-use wiper, driver and/or passenger side.

### BACKGROUND OF THE INVENTION

### Field of Invention

The present invention relates to automotive windshield wiper systems of a motor vehicle. Specifically to a flexible and versatile cover to sheath over a damaged or failed wiper frame assembly and/or wiper blade for emergency implementation to enable provisional operation of the usual reciprocating powered windshield wiper system and allow continued limited travel of a vehicle during periods of rain/precipitation.

The invention of Lenardo Nelson Sr. (U. S. Pat. No. 6,233,779 B1), (2001) discloses a multi-faceted windshield wiper blade in a receiving bracket of a windshield wiper frame assembly for normal operation of the windshield wiper system during inclement weather. This invention provides for wiper blade renewal by removing entirely the multi-faceted blade from the receiving bracket and rotating the blade axially to expose an unused facet of the blade to face the vehicle windshield and reinserting the blade back into the receiving bracket to continue use of the wiper system. This invention provides for adaptability of the wiper blade in the event of damage or failure of the in-use wiper blade facet but makes no provision for damage or failure of the wiper frame assembly.

The blade facet renewal of this invention also may not be suitable for those lacking in mechanical skill or knowledge. The invention of Liang-Yuan Chen (U. S. Pat. No. 6,038,730), (2000) discloses a wiper frame assembly comprising a flexor and at least two claw units wherein a replacement wiper blade can be stowed there-between in the event of wiper blade damage or failure. The in-use wiper blade can be replaced by fully removing it from the wiper frame assembly then extracting the stowed replacement wiper blade from the stow position and inserting the replacement wiper blade into the operative side of the wiper frame assembly. However this invention too makes no provision for a damaged or failed wiper frame assembly. The stowed replacement wiper blade also may not be operatively changeable by those lacking in mechanical skill or knowledge. In addition the stowed replacement blade is exposed to weather while in the stow position so accordingly may not be in satisfactory condition for use when needed.The invention of Albert Lee (U. S. Pat. No. 6,598,258 B2), (2003) discloses a winter windshield wiper frame assembly comprising a bridge member connected to a frame having an upper portion of the wiper frame assembly fully encased by a cover member therein creating an air flow channel there-between the covered frame assembly and the bridge member so as to operate with less than normal wind resistance and whereas the sheet member blocks ice particles from accumulating within the wiper frame assembly. This invention meets it's expected objectives, however there is no provision for a damaged or failed wiper frame assembly and/or wiper blade.

Heretofore none of the above patents provide for rapid wiper parts replacement or repair in a rain related driving situation by those lacking in mechanical knowledge or skill. Additionally the vehicle may be in a location and/or non-business hours time where specific type and size wiper replacement parts or services are not available.

### Objects and Advantages of the Present Invention

Several objects and advantages of the present invention are to provide:

(a) an economical temporary solution to a damaged or failed windshield wiper frame assembly and/or wiper blade during travel in rain/precipitation if continued short term driving is desired or necessary regardless of inclement weather conditions.

(b) a widely versatile cover to slide over and contain most any type or size wiper frame assembly including the wiper blade to temporarily substitute a damaged or failed wiper member.

(c) a temporary wiper repair that can be provided for most any time and/or location due to a general availability of the present invention in local and remote 24 hour gas station/convenience stores and many other common retail outlets.

(d) a generic short term wiper repair that can be provided for by stowing the present invention within a vehicle as with any other emergency implements and with out regard to matching a particular type or size of wiper frame assembly or wiper blade.

(e) an extremely simplistic short term repair that can be accomplished in a stressful rain travel situation by most anyone, including those lacking in mechanical skill or knowledge.

(f) a temporarily extended driving range (generally 2-4 hours at up to 55 miles per hour) after unexpected wiper frame/assembly and/or wiper blade failure while driving in rain conditions and use of the present invention to avoid being stranded during rain due to lack of visibility at an unintended location and allowing for end destination travel or at least travel to a temporarily convenient location.

(g) furthermore, a means to prevent damage to the glass surface of a windshield when continued use of a damage or failed wiper frame assembly and/or wiper blade during rain driving without the present invention installed could result in metal or plastic wiper frame members making reciprocating motive contact with the windshield causing damage to the glass (driver and/or passenger side).

### DESCRIPTION OF THE DRAWING FIGURES

FIG. 1A Perspective of the jacket (the present invention).

FIG. 1B Partial detail in perspective of one end of the jacket.

FIG. 1C Partial detail in perspective of an upper mid portion of the jacket.

FIG. 2A Exploded single line assembly of the jacket in perspective.

FIG. 2B End view assembly of the jacket.

FIG. 3A Top view of the jacket (broken view).

FIG. 3B Cross section of a mid portion of the jacket as seen from FIG. 3A.

FIG. 4A Single line elevation of a conventional type windshield wiper (left) and a single line elevation of the jacket (right).

FIG. 4B End view of a conventional type windshield wiper and a phantom outline end view of the jacket in place over the conventional type windshield wiper.

FIG. 4C Alternate position single line end view of the jacket in stand-alone form and a phantom outline end view of the jacket flexed as if in use with a conventional type wiper.

FIG. 4D Single line perspective of the jacket in place over a phantom outline perspective of a conventional windshield wiper.

FIG. 5A Single line elevation of a low profile type windshield wiper (left) and a single line elevation of the jacket (right).

FIG. 5B End view of a low profile type windshield wiper and a phantom outline end view of the present invention in place over the low profile type wiper.

FIG. 5C Alternate position single line end view of the jacket in stand-alone form and a phantom outline end view of the jacket flexed as if in use with a low profile type wiper.

FIG. 5D Single line perspective of the jacket in place over a phantom outline perspective of a low profile type windshield wiper.

DRAWING FIGURE ELEMENTS OF JACKET 2
(THE PRESENT INVENTION)

| | |
|---|---|
| 2 | repair jacket |
| 4 | containment casing |
| 6 | convex upper sidewall |
| 8 | concave lower sidewall |
| 10 | linear fold crease |
| 12 | linear guide gap |
| 14 | longitudinal recess cut out |
| 15 | rectangular open mid gap |
| 16 | end edge |
| 18 | through opening |
| 20 | upper sidewall edge |
| 22 | partial perimeter edge |
| 24 | inner corners |
| 26 | outer corners |
| 28 | outer corners |
| 30 | outer corner rounds |
| 32 | base core |
| 34 | through groove |
| 36 | core edge |
| 38 | adhesive area |

### DRAWING FIGURE ELEMENTS OF A CONVENTIONAL TYPE WINDSHIELD WIPER STRUCTURE FOR DESCRIPTIVE PURPOSE ONLY OF THE PRESENT INVENTION

4O conventional (type) windshield wiper frame
41 bridge
42 primary yoke
43 receiving saddle
44 secondary yoke
45 connecting rod
46 mounting stay
48 flex strip
50 wiper blade

### DRAWING FIGURE ELEMENTS OF A LOW PROFILE TYPE WINDSHIELD WIPER STRUCTURE FOR DESCRIPTIVE PURPOSE ONLY OF THE PRESENT INVENTION

52 low profile (type) windshield wiper assembly
54 bridge
56 main body
58 end cap
60 wiper blade
62 receiving saddle
64 connecting rod

### DETAILED DESCRIPTION OF THE PRESENT INVENTION

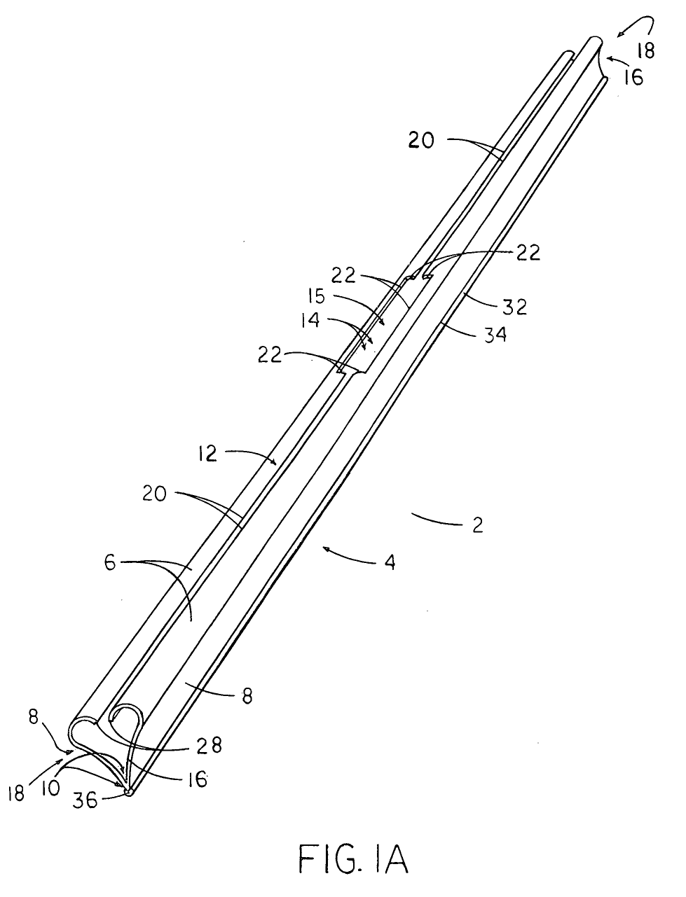

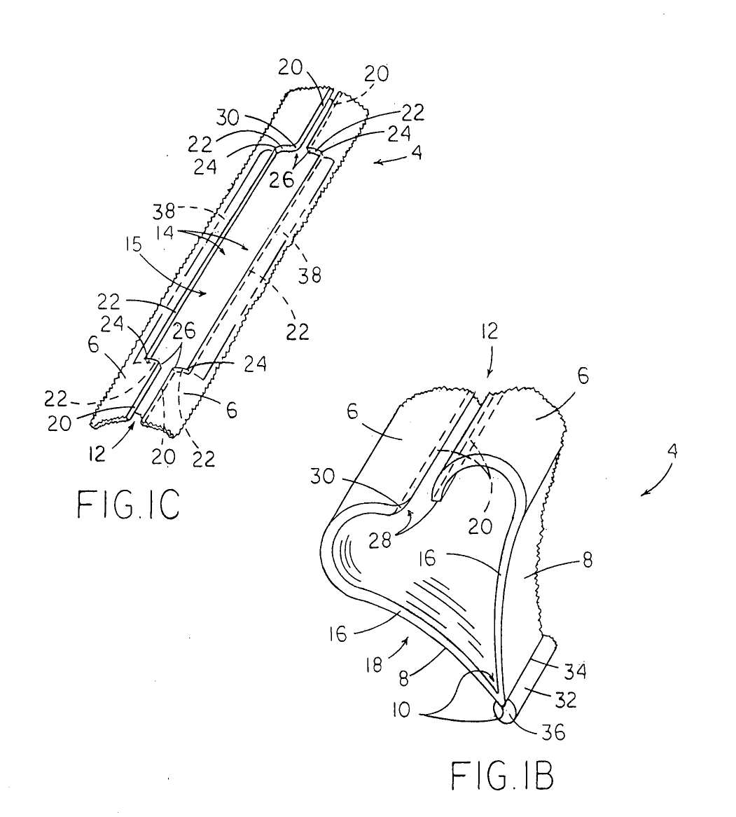

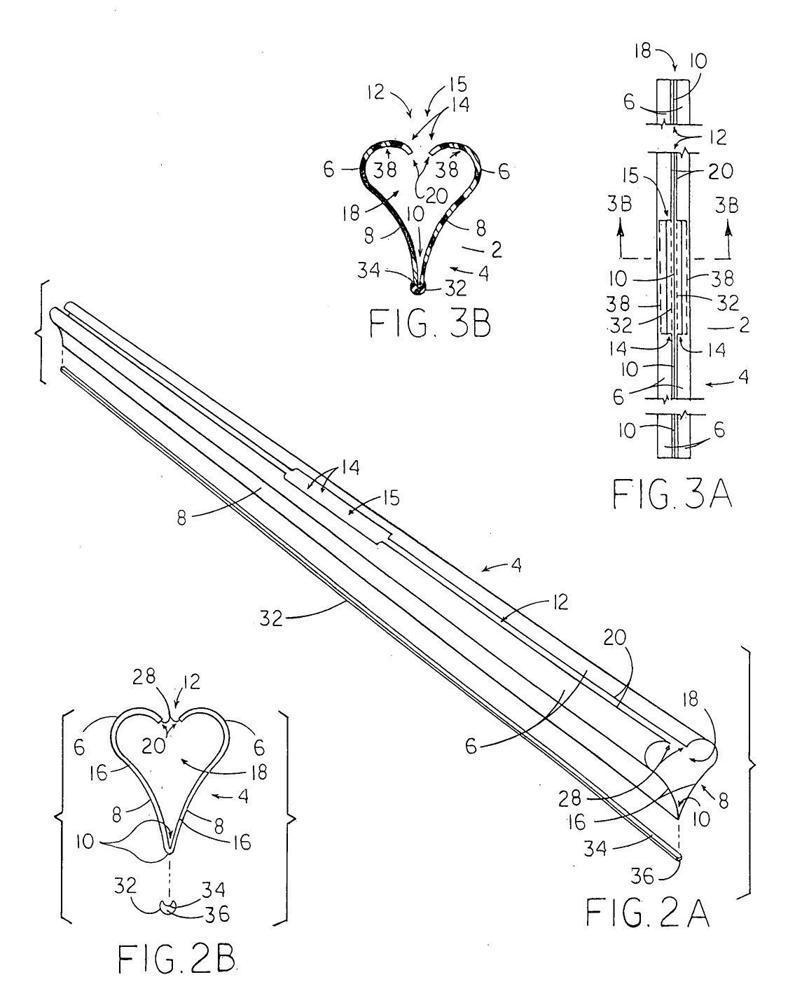

As illustrated and described by the drawings and other reference the present invention is a temporary repair jacket 2 shown in drawing (FIG. 1A) wherein jacket 2 in the preferred embodiment comprises an approximate overall length of 457.200 mm/18 inches, an approximate overall height of 14.288 mm/ 9/16 inches and an approximate overall width of 9.525 mm/⅜ inches. The present invention comprises an elongated substantially tubular yieldable clutch containment casing 4 as shown in drawing (FIG. 2A) and is the major component of the jacket so accordingly maintains the length and width of jacket 2 but comprises an approximate overall height of 12.700 mm/½ inches. The preferred material of casing 4 is any of a common flexible plastics such as polystyrene at an approximate thickness of 0.794 mm/ 1/32 inches. All given dimensions are approximations only and not limiting to these measurements. The aforementioned polystyrene material is available from United States Plastic Corporation of Lima Ohio, however casing 4 can be of other plastics or vinyl materials that are flexible, resilient and durable and are available from numerous suppliers.

In profile, the preferred embodiment of casing 4 beginning from a centrally open upper portion, is defined by an opposing arced convex sidewall 6 each side respectively. Wherein each sidewall 6 is tangent to and in transition with an opposing arced concave sidewall 8 respectively each side of the casing. Further defining casing 4 wherein sidewalls 8,8 converge together at a lower central portion of casing 4 to form a single linear fold crease 10 as shown in drawing (FIGS. 2A and 2B). Sidewalls 6,6, sidewalls 8,8 and crease 10 configure the major portion lateral and linear shape of casing 4 as shown in drawing (FIGS. 2A and 2B). Between sidewalls 6,6 at a central upper portion of casing 4 is a linear guide gap 12. Each sidewall 6 respectively includes each a linear sidewall edge 20 shown in drawing (FIGS. 1A, 1B and 2B). Sidewalls 6,6 form an outward arc at an approximate radius of 2.381 mm/ 3/32 inches and sidewalls 8,8 form an inward arc at an approximate radius of 19.050 mm/¾ inches. The open width of gap 12 is approximately 2.381 mm/ 3/32 inches in a stand alone non-use state but will widen accordingly in use. Sidewalls 6,6, sidewalls 8,8 and gap 12 shown in drawing (FIGS. 1A, 1B, 2A, 2B). All dimensions given are approximations only.

From an upper center portion of casing 4 and communicating gap 12 linearly is a rectangular open mid gap 15 therein formed by a longitudinal recess cut out 14 to each respective sidewall 6. Each cut out 14 respectively includes a plurality of partial perimeter edges 22, 22 and a plurality of inner corners 24, 24, drawing (FIG. 1C). Each cut out 14 is approximately 3.175 mm/⅛ inches in width and approximately 76.200 mm/3 inches in length. An approximate width of gap 15 is 8.731 mm/ 11/32 inches in a stand alone non-use state but will widen accordingly in use. An approximate length-of gap 15 is equal to the length of cut outs 14,14. All dimensions given are approximations only. Edges 22,22 converging with respective perpendicularly adjacent edges 20,20 form a plurality of outer corners 26,26 there-between gap 12 and gap 15, drawing (FIG. 1C). All corners 26,26 are rounded to form a plurality of outer corner rounds 30,30 wherein each round 30 is of an approximate 1.588 mm/ 1/16 inches radius. Round 30 is shown in a single corner 26 there-between gap 12 and gap 15, drawing (FIG. 1C).

Casing 4 comprises a through opening 18 with each opposing end of casing 4 terminating in an end edge 16 as shown in drawing (FIGS. 1A,2A and 2B), noting that each side and each end of casing 4 respectively are identical. Each edge 16 and respective perpendicularly adjacent edges 20,20 converge to form a plurality of outer corners 28,28. All corners 28,28 are rounded to the aforementioned round 30 as shown in a single corner 28 for one end of casing 4 in drawing (FIG. 1B).

Connected to casing 4 to the linear underside of crease 10 is an elongated substantially solid scrub base core 32. The preferred embodiment of core 32 in cross section is solid and round but core 32 can be a variable fluid overlay or other shapes and consistencies applied to crease 10 (overlay not shown). The preferred Core 32 comprises a linear through groove 34 for connecting core 32 to crease 10 of casing 4. Core 32 and crease 10 are adhesively joined (FIGS. 2A and 2B), (adhesive not shown). The length of core 32 is preferably equal to the length of casing 4 and terminates each end respectively in a core edge 36. A preferred diameter of core 32 is 3.175 mm/⅛ inches but not limiting to these dimensions. Groove 34 in length is preferably equal to the length of core 32 and is of a depth and shape to accommodate the underside of crease 10 (FIGS. 2A,2B and 3B). Core 32 is of a rubber material common to present use in typical windshield wiper blades and is available from Granger Industrial Supply of Pensacola, Fla.

From an upper mid portion of casing 4 into a portion of each inner surface of each sidewall 6 respectively adjacent each cut out 14 is an adhesive area 38 following the arced inside form of each sidewall 6, (FIGS. 1C, 3A and 3B). A preferred width of each area 38 is 3.175 mm/⅛ inches and preferably equal in length to each respective cut out 14, drawing (FIG. 1C,3A and 3B). Areas 38,38 are respectively applied with a viscid, malleable, water insoluble adhesive bonded to each area 38 (adhesive not shown). The exposed portion face of each adhesive application is fully sealed with a common non-permanent peel-off pull tabbed seal with pull tab ends extending fully outside of casing 4 at each respective cut out 14 there-from gap 15 so as to remain readily accessible for pull tabbed seal removal upon needed use of the present invention. Adhesive and pull tab seal is available from USAdhesives of Chicago, Ill. (adhesive and pull tabbed seal not shown). All dimensions are approximations.

### Manufacture Description of Jacket 2 the Present Invention

In an extrusion machine casing 4 of jacket 2 can be extruded from a preferred plastic material in bulk lengths with a machine die of the casing profile in the path of the plastic within the extruder, then cut to the preferred lengths with cut outs 14,14 machine stamped or manually cut out. Adhesive areas 38,38 can be accessed through cut outs 14,14 therein gap 15 to apply adhesive and removable seal and pull tab to each area 38 from a dispensing machine or manually (adhesive and pull tabbed seal not shown). Casing 4 can also be die cast from a mold or can be stamped out from a flat material then roll developed and folded into form. Either method of manufacture can be of a pigmented plastic for color, however the use of a pigment to color casing 4 will be of further labor and material than is necessary.

In an extrusion machine core 32 can be extruded in rope-like bulk form with groove 34 simultaneously formed using a notch in the path of the preferred rubber material within the extruder, then core 32 cut to preferred lengths and adhesively bonded (adhesive not shown) to casing 4 linearly to the underside of crease 10. Core 32 can alternatively be a variable fluid rubber overlay applied directly to the linear underside of crease 10 in either form core 32 is bonded to casing 4 in a linear manner to the underside of crease 10, drawing (FIGS. 2A, 2B and 3B), therein completing the manufacture of jacket 2.

### Conventional Type Windshield Wiper Structure Description for Later Descriptive Aid only in Use of the Present Invention

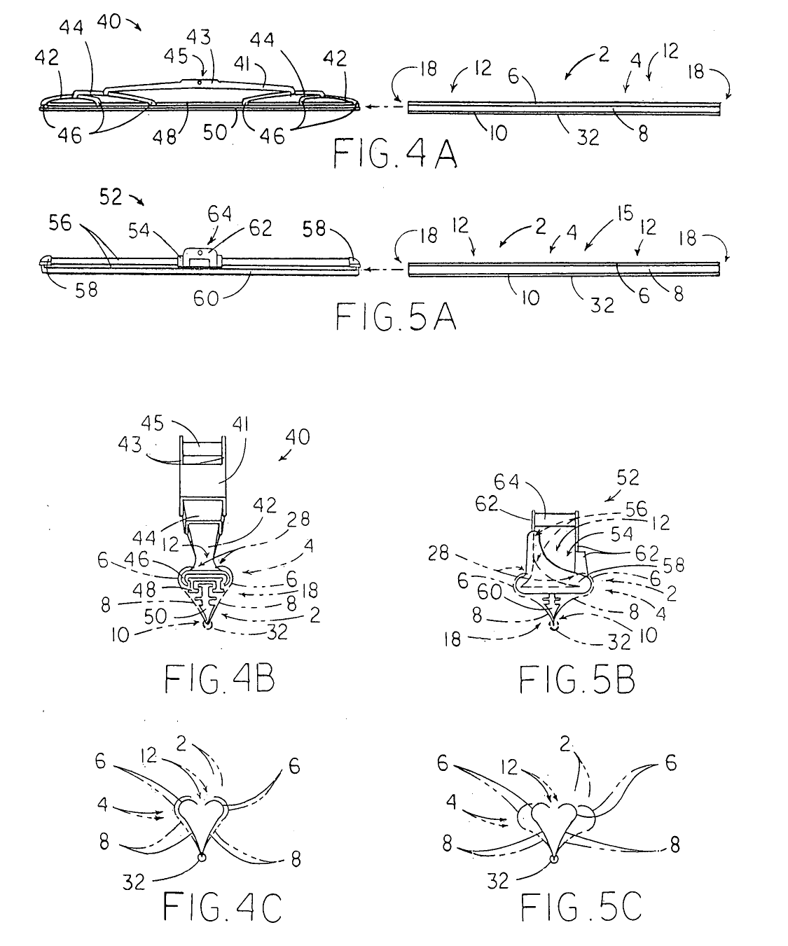

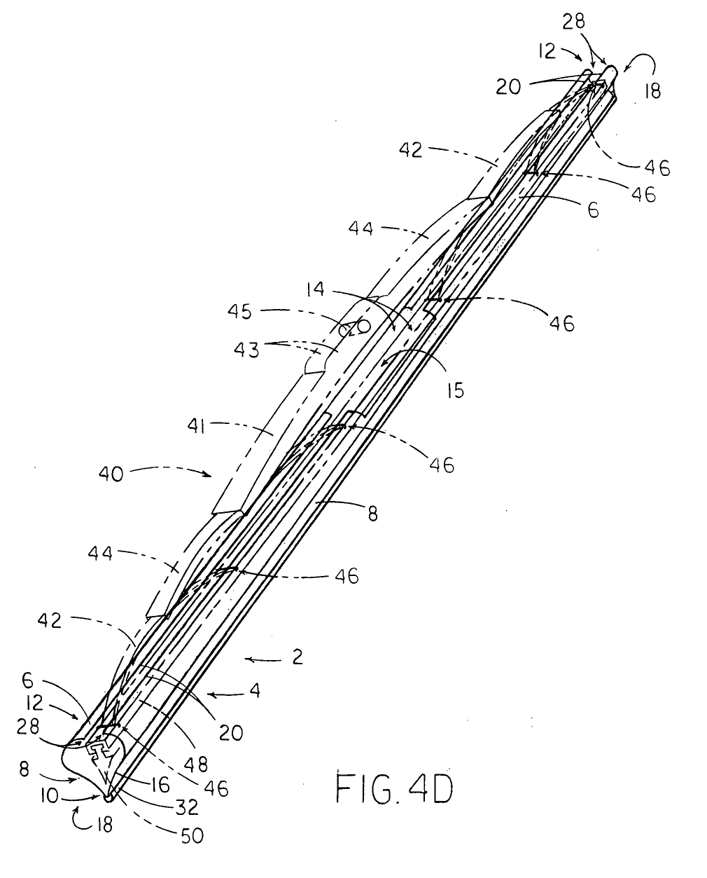

Now will be described key elements of a conventional type windshield wiper structure to facilitate later description in the use of the present invention. A conventional windshield wiper structure 40 shown in drawing (FIG. 4A left) is connected to a typical windshield wiper power arm of a vehicle's usual powered wiper system, (power arm and wiper system not shown). Structure 40 comprises an elongated frame member bridge 41 that is connected to a plurality of frame member secondary yokes 44,44. Yokes 44,44 are connected to a plurality of frame member primary yokes 42,42 wherein yokes 42,42 and yokes 44,44 comprise a plurality of frame member mounting stays 46,46. Stays 46,46 engage an elongated flex strip 48 wherein strip 48 engages an elongated rubber wiper blade 50. The vehicle's wiper power arm (power arm not shown) engages structure 40 through a receiving saddle 43 and is connected to a connecting rod 45 of structure 40 (conventional type wiper), (FIG. 4A left).

### Low Profile Type Windshield Wiper Structure Description for Later Descriptive Aid only in Use of the Present Invention

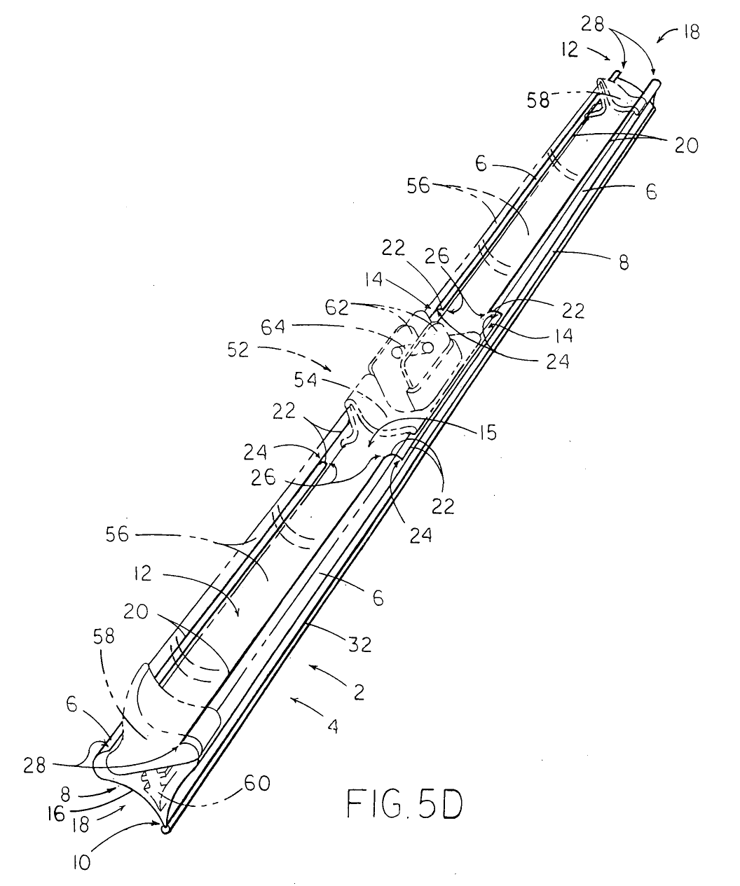

Now will be described key elements of a low profile type windshield wiper structure to facilitate later description in the use of the present invention. A low profile windshield wiper structure 52 shown in drawing (FIG. 5A left) is connected to a typical windshield wiper power arm of a motor vehicle's usual powered wiper system, (power arm and wiper system not shown). Structure 52 comprises an assembly member bridge 54, wherein bridge 54 is connected to an elongated main body 56 and wherein each end of body 56 terminates in an end cap 58. The underside of body 56 engages an elongated rubber wiper blade 60 as shown in drawing (FIG. 5A left). The vehicle's wiper power arm (power arm not shown) engages structure 52 through a receiving saddle 62 and is connected to a connecting rod 64 of structure 52 (low profile type wiper),(FIG. 5A left).

### Operational Description of the Present Invention for Use with a Conventional Type Wiper Structure

Now will be described the manner of use of the present invention (jacket 2),(FIG. 4A right) with a conventional type windshield wiper structure (FIG. 4A left). Pull the aforementioned tabbed adhesive seals along and through gap 15 to expose adhesives of areas 38,38, (pull tabs and adhesives not shown), areas 38,38 shown in drawing (FIG. 1C, 3A and 3B). Therewith structure 40 being normally connected to a vehicle's windshield wiper power arm (wiper power arm not shown) lift structure 40 up and away from the vehicle windshield (windshield not shown) in the most convenient and yielding position for handling. Place jacket 2 in tandem alignment end to end with structure 40, drawing (FIG. 4A), noting that either end of jacket 2 can be placed to either end of structure 40. Manually slide jacket 2 over and around structure 40 through opening 18 of the jacket where blade 50 will enter opening 18 to the inner side of crease 10. Edge 16, corners 28,28 and edges 20,20 of jacket 2 will flex over and around each side of strip 48 and stays 46,46 of yokes 42,42 and yokes 44,44 of structure 40 therein outwardly flexing sidewalls 6,6 and sidewalls 8,8 of jacket 2, flexing positions shown separately, drawing (FIG. 4C). Gap 12 and gap 15 will simultaneously widen, further easing slide action until jacket 2 is centered linearly and laterally over structure 40,drawing (FIG. 4D).

Place the now combined jacket 2 and structure 40 back down atop the vehicle's windshield with core 32 making full linear contact with the glass surface of the windshield (windshield not shown). The now combined jacket 2 and structure 40 are shown in drawing (FIGS. 4B and 4D), (placement of combined jacket 2 and structure 40 to windshield not shown). For any portions of structure 40 that may protrude beyond the ends of jacket 2 and may be making contact with the windshield, manually bend the protruding portions up enough to clear the undesired contact with the windshield, (protruding portions and bending not shown). The already failed structure 40 nevertheless, will need to be replaced at a less urgent time and/or location.

An already present down force exists within structure 40 from the vehicle's usual wiper system spring loaded power arm that is connected to structure 40. This existing down force automatically transmits through jacket 2 holding core 32 firmly against the glass surface of the windshield,(power arm, windshield and down force not shown). The now flexed sidewalls 6,6 and sidewalls 8,8 of the jacket create a bilateral clutch force linearly along structure 40, this together with the previously mentioned down force and the aforementioned adhesive all work together to hold jacket 2 in place for operation once reciprocal power motion is supplied normally to the usual powered wiper system. Gap 15 of the jacket is not necessary for use with a conventional type windshield wiper but does not interfere with this application. Gap 15 will be further described.

### Operational Description of the Present Invention for Use with a Low Profile Type Wiper Structure

Preliminary positioning and alignment for operational use of jacket 2 (the present invention) with the previously described structure 40 (conventional type wiper structure), (FIG. 4A) are the same positioning and alignment to proceed with for operational use of jacket 2 with structure 52 (low profile type wiper structure), drawing (FIG. 5A).

Following the previous preliminary steps begin slide action of jacket 2 toward and over one end of structure 52 through opening 18 wherein edge 16,corners 28,28 and edges 20,20 of jacket 2 will engage cap 58 ,blade 60 and body 56 of structure 52. Opening 18, edge 16 ,corners 28,28 ,edges 20,20 shown in drawing (FIGS. 2A and 2B). Cap 58, body 56 and blade 60 shown in drawing (FIG. 5A left). With further slide motion of jacket 2 over structure 52, sidewalls 6,6 and sidewalls 8,8 of the jacket flex outwardly, simultaneously widening gap 12 and gap 15 further easing slide action of jacket 2 over and around structure 52, drawing (FIG. 5D). Flexing of sidewalls 6,6 and sidewalls 8,8 shown separately, drawing (FIG.5C). With continued slide motion, edge 16 ,corners 28,28 and edges 20,20 of jacket 2 will engage and flex over and around the inward side of the opposing cap 58 of structure 52 therein centering jacket 2 laterally and linearly over and around structure 52. Edges 22,22, corners 24,24 of each respective cut out 14 including gap 15 of the jacket form a partial perimeter around bridge 54, centering jacket 2 in place over structure 52, drawing (FIGS.5B and 5D). Final repositioning steps in the operational description for jacket 2 combined with structure 52 (low profile type wiper structure) are the same as for final repositioning and operation of jacket 2 combined with structure 40 (conventional type wiper structure) as previously mentioned .

SUMMARY OF THE PRESENT INVENTION

The present invention is a separate entity from the usual windshield wiper frame assembly and wiper blade of a motor vehicle but can substitute normal function of a damaged or failed wiper frame assembly and/or blade for short term operation of the wiper system to allow continued temporary travel of a vehicle during rain/precipitation. The present invention comprises an elongated, generally tubular plastic casing with flexible sides, a linearly open top portion and an elongated narrow rubber wiping strip connected to the casing underside. Several advantages of the present invention are:

(a) an economical substitute repair for temporary relief and continued windshield wiper system use for a damaged or failed wiper frame assembly and/or wiper blade.

(b) a temporary wiper repair that can be performed quickly and easily in a stressful rain related driving situation with minimal mechanical skill or knowledge.

(c) a generic short term repair jacket that can be stowed within the vehicle as with any other emergency implements without regard to size or type of replacement wiper parts.

(d) a temporary repair that will prevent a motorist from being stranded during rain in the event of wiper damage or failure in transit.

(e) a short term wiper repair jacket that can be widely distributed for most any location or time by being available in 24 hour convenience stores and many other similar outlets.

(f) a temporary repair jacket that can be installed from either end of the jacket to either end of the failed wiper frame assembly.

(g) a short term repair that will prevent damage to the glass surface of a vehicle windshield by containing damaged or failed wiper parts ,driver and/or passenger side while the wiper system remains in use.

Now having described a preferred embodiment of the present invention, it's manufacture and use, this description should not be construed as limiting the scope of the invention but as illustrations only of the preferred embodiment. Therefore the spirit and scope of the invention should be limited only by the appended claims and their legal limitations rather than by the illustrations and description given.

I claim:

1. An adaptable interim repair jacket to supplant a failed windshield wiper structure of a motor vehicle; therewith said jacket comprising:
(a) a flexible clutch encasement means wherein said encasement means is arranged to yieldingly accommodate clench and encase said wiper structure of a conventional group; and wherein said encasement means is arranged to yieldingly accommodate clench and encase said wiper structure of a low profile group; included therein said encasement means;
(b) a glutinous adherence means wherein said adherence means is arranged to adhere said encasement means to said wiper structure of a conventional type; and wherein said adherence means is arranged to adhere said encasement means to said wiper structure of a low profile type; and wherein said encasement means in combination further includes;
(c) a basal element scrub means wherein said scrub means is arranged to clean a glass surface of a vehicle windshield when said scrub means is moved across said surface; and wherein said scrub means is power impelled in reciprocal motion therewith the employment of said jacket including said encasement means and said scrub means thereto said wiper structure;and wherein said wiper structure is typically connected to a usual powered reciprocating motion windshield wiper system of said vehicle; and
wherein power is applied normally.

2. The jacket according to claim 1 wherein said encasement means comprises an elongated substantially tubular accommodating containment casing wherein said casing include a major portion through opening and wherein said casing terminates each opposing end therein an end edge; and wherein
said casing further includes said scrub means wherein said scrub means comprises an elongated base core wherein said core terminates each opposing end therein a core edge; and wherein
said core include an accommodating through groove therein a portion of said core linearly from one said core edge to the opposing said core edge;and wherein
said casing include said adherence means.

3. The jacket according to claim 2 wherein said casing includes from a central upper portion thereof an accommodating linear gap along and through said upper portion from one said end edge to the opposing said end edge and communicating said opening therein dividing said upper portion; wherein
from each opposing side of said linear gap therein is an outwardly bulbous convex radial upper sidewall linearly along each opposing side of said casing wherein each said upper sidewall include respectively a sidewall edge linearly adjacent each said upper sidewall; and wherein
each said upper sidewall traverse and transition in a radial manner and in continuity therein an inwardly concave radial lower sidewall linearly along each lower side of said casing; wherein
each said lower sidewall traverse in a radial manner and in continuity to converge respectively and terminate therein a single linear fold crease along the linear underside of said casing; wherein
each said upper sidewall in continuity with each said lower sidewall respectively is flexibly resilient bilaterally in a radial manner therefrom a linear central portion thereof said crease wherein said core is connected to said casing therein said groove linearly conjoined to said crease; and wherein
said adherence means comprises a gelatinous malleable adhesive.

4. The jacket according to claim 3 wherein said casing include from said upper portion a substantially rectangular accommodating recess gap therein each opposing said upper sidewall communicating centrally and in part linearly with said linear gap and said opening wherein each said recess gap include a plurality of partial perimeter edges adjacent each said recess gap; and wherein
to an inner surface portion thereof each said upper sidewall adjacent the longitudinal side thereof each said recess gap there is included a substantially rectangular adhesive area wherein each said adhesive area include each an employment thereof said adhesive; and wherein
Included therebetween the combined opposing boundaries of said perimeter edges therein is a substantially rectangular accommodating mid gap.

5. The jacket according to claim 2 wherein said casing comprises a flexibly resilient and durable plastic.

6. The jacket according to claim 2 wherein said core comprises a flexibly resilient and durable rubber.

7. The jacket according according to claim 2 wherein said core comprises a flexibly resilient synthetic rubber.

8. The jacket according to claim 4 wherein each said adhesive employment include each a topical cover seal; wherein each said seal is releasable; and wherein said adhesive is water insoluble.

9. The jacket according to claim 5 wherein said plastic comprises polyethylene.

10. The jacket according to claim 5 wherein said plastic comprises polypropylene.

11. The jacket according to claim 5 wherein said plastic comprises polystyrene.

12. The jacket according to claim 5 wherein said plastic is admixed with a pigment for color.

13. The jacket according to claim 2 wherein said scrub means comprises a variable viscosity fluid base core.

14. The jacket according to claim 13 wherein said fluid base core comprises a viscid synthetic rubber.
